(19) United States
(12) Patent Application Publication
(10) Pub. No.: US 2016/0347927 A1
(43) Pub. Date: Dec. 1, 2016

(54) Process to Improve the Yield of Chemical Polyurethane Foam Recycling

(71) Applicants: Kambiz TAHERI, North Vancouver (CA); Naser BARZANDEH, North Vancouver (CA); Joey Chung Yen YUNG, Vancouver (CA)

(72) Inventors: Kambiz Taheri, Vancouver (CA); Naser Barzandeh, Vancouver (CA); Joey Chung Yen Yung, Vancouver (CA)

(73) Assignee: Polymer Research Technologies Ltd., North Vancouver, BC (CA)

(21) Appl. No.: 14/915,610

(22) PCT Filed: Aug. 27, 2014
(86) PCT No.: PCT/CA2014/000651

§ 371 Date: Feb. 29, 2016

Related U.S. Application Data
(60) Provisional application No. 61/870,759, filed on Aug. 27, 2013.

(51) Int. Cl. C08J 11/24; C08J 11/14; B01J 19/24; C08J 11/16

(52) U.S. Cl. CPC C08J 11/24; C08J 11/16; C08J 11/14; B01J 19/24; C08J 2375/04; B01J 2219/24

(57) ABSTRACT

A process to enhance the chemical recycling of polyurethane foam comprises improving the process of grinding (which is a necessary precursor to chemolysis reactions), by employing a wetting process, concurrent with grinding, which reduces the loss of foam during grinding process.

### FIELD OF THE INVENTION

The present invention relates to improving the efficiency of the chemical polyurethane foam recycling process.

### BACKGROUND OF THE INVENTION

“Polyurethane” (referred to also herein as “PU”) describes a general class of polymers prepared by polyaddition polymerization of diisocyanate molecules and one or more active-hydrogen compounds. “Active-hydrogen compounds” include water and polyfunctional hydroxyl containing (or “polyhydroxyl”) compounds such as diols, polyester polyols, and polyether polyols. Active-hydrogen compounds also include polyfunctional amino-group-containing compounds such as polyamines and diamines. A common example of a polyether polyol is a glycerin-initiated polymer of ethylene oxide or propylene oxide.

“Polyurethane foams” are formed via a reaction between one or more active-hydrogen compounds and a polyfunctional isocyanate component, resulting in urethane linkages. Polyurethane foams are widely used in a variety of products and applications. These foams may be formed in wide range of densities and may be of flexible, semi-flexible, semi-rigid, or rigid foam structures. Generally speaking, “flexible foams” are those that recover their shape after deformation. In addition to being reversibly deformable, flexible foams tend to have limited resistance to applied load and tend to have mostly open cells. “Rigid foams” are those that generally retain the deformed shape without significant recovery after deformation. Rigid foams tend to have mostly closed cells. “Semi-rigid” or “semi-flexible” foams are those that can be deformed, but may recover their original shape slowly, perhaps incompletely. A foam structure is formed by use of “blowing agents.” Blowing agents are introduced during foam formation through the volatilization of low-boiling liquids or through the formation of gas due to chemical reaction. For example, a reaction between water and isocyanate forms carbon dioxide (CO₂) gas bubbles in polyurethane foam. This reaction also generates heat and results in urea linkages in the polymer. Additionally, surfactants may be used to stabilize the polymer foam structure during polymerization. Catalysts are used to initiate the polymerization reactions forming the urethane linkages and to control the blowing reaction for forming gas. The balance of these two reactions, which is controlled by the types and amounts of catalysts, is also a function of the reaction temperature.

Overall, PU are one of the most important groups of plastics, and for this reason, their recycling has been well studied over the past two decades. One method to recycle waste PU is through chemical recycling via hydrolysis, glycolysis, and methanolysis, to produce recycled constituent polyol. However, no known method of chemical recycling has been commercialized and practiced to date.

Recently, legislative measures for PU waste measures have increased the overall economical costs of PU, which brings urgency for PU manufacturers to reinvestigate chemical recycling. The goal has been to find an economical, high product yield, high efficiency chemical recycling process includes 1) grinding the waste PU foam into small pellets; 2) feeding the pellets through the chemolysis (ex: glycolysis) process; and 3) clarification of the generated recycled polyol.

In the grinding process (particularly necessary as a first step for rigid foam recycling), waste PU foam was fed through a grinder to reduce the size to smaller pellets such as 1″×1″×1″ cubes. In the chemolysis (ex: glycolysis) process, the polyurethane chain is then degraded by successive trans-esterification reactions of the urethane bond with low molecular weight glycols, often with diethylene glycol (DEG) and the aid of a catalyst; here catalysts used in polyurethane glycolysis include bases like amines, hydroxides, alkoxides, and Lewis acids. In the clarification process, the unwanted solid is removed through a process such as filtration.

Concerns about the overall efficiency of the chemical recycling process, the formulation of chemolysis (ex: glycolysis), purification and performance of the recycle polyol have created barriers for the commercialization of the chemical recycling of PU.

In addition, one of the factors affecting efficiency of the chemical recycling process is the amount of foam lost during grinding. During grinding, a dry, fine foam dust is generated and suspended in the air. The non-captured foam dust often constitutes approximately 15% of the total scrap foam. Moreover, it a hazard to work with and may be explosive.

It is an object of the present invention to obviate or mitigate all or some the above disadvantages.

### SUMMARY OF THE INVENTION

The present invention provides, in one aspect, a process of chemically recycling polyurethane waste comprising the steps of:
a) wet grinding the polyurethane waste with a polyol to form a wet ground polyurethane;
b) subjecting wet ground polyurethane to a chemolysis reaction to produce at least one chemolysis polyol;
c) using the chemolysis polyol produced at step b) in the wet grinding of step a), therein to control dust generation during said grinding and to improve efficiency of the chemical recycling.

The present invention provides, in another aspect, wet ground waste polyurethane for use in a subsequent chemolysis reaction comprises a waste polyurethane ground in the presence of a chemolysis polyol.

The present invention provides, in another aspect a system for polyurethane foam recycling which comprises:
a) grinder with intake portal for receiving chemolysis polyol, said grinder adapted to grind waste polyurethane in the presence of at least one chemolysis polyol therein to create wet ground polyurethane;
b) chemical recycling chamber;
c) feeding channel from grinder to chamber, to transfer wet ground polyurethane;
d) feedback channel from chemical recycling chamber to grinder by which chemolysis polyol is delivered from chemical recycling chamber to grinder.

An object of the present invention is to enhance the chemical recycling of polyurethane. This is achieved by improving the process of grinding which is a necessary precursor to chemolysis reactions. Unlike known processes, the current invention employs wetting process, concurrent with grinding. This wet grinding process reduces the loss of the foam during grinding process.

Compared to conventional chemical recycling process, the current invention employs chemicals used to recycle polyol, as wetting media that are mixed with the scrap foam (preferably by spraying) during grinding. Recycle polyol, generated through a chemolysis process (preferably glycolysis), will not react with the scrap foam and the “chemolysis” chemicals can thus be used in the wet grinding process as well.

The advantages of employing recycle polyol as wetting media are many, and are particularly evident in terms of their lack of impact on the subsequent chemolysis reaction.

For the chemical recycling process, the invention improves product yields and lessens process safety concerns. Compared to conventional chemical recycling processes, the current invention improves the yield of chemical recycling process by approximately 10 to 15%.

### DESCRIPTION OF THE FIGURES

The following FIGURE sets forth embodiments in which like reference numerals denote like parts. Embodiments are illustrated by way of example and not by way of limitation in the accompanying FIGURE.

FIG. 1 is a schematic flow-chart diagram illustrating one embodiment of a method for incorporating recycle polyol into the wet grinding process in accordance with the present invention.

### PREFERRED EMBODIMENTS OF THE INVENTION

A detailed description of one or more embodiments of the invention is provided below along with accompanying FIGURE that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise. The term “plurality” means “two or more”, unless expressly specified otherwise.

The term “herein” means “in the present application, including anything which may be incorporated by reference”, unless expressly specified otherwise.

In this specification the terms “comprise, comprises, comprised and comprising” and the terms “include, includes, included and including” are deemed to be totally interchangeable and should be afforded the widest possible Interpretation.

The term “e.g.” and like terms mean “for example”, and thus does not limit the term or phrase it explains.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. section 1.72(b). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present invention provides, in one aspect, a process of chemically recycling polyurethane waste comprising the steps of:
a) wet grinding the polyurethane waste with a polyol to form wet ground polyurethane;
b) subjecting wet ground polyurethane to a chemolysis reaction to produce at least one chemolysis polyol;
c) using the chemolysis polyol produced at step b) in the wet grinding of step a), therein to control dust generation during said grinding and to improve efficiency of the chemical recycling.

It has been identified in the art that chemolysis processes such as glycolysis, hydrolysis, methanolysis and aminolysis can be used for depolymerization and recycling of polyurethane scrap, as well as condensation polymers such as polyesters (e.g., PET), polyamides (e.g., nylons), and polyureas (e.g., RIM, RRIM, SRIM). Major differences between glycolysis, hydrolysis, methanolysis and aminolysis are in the type of reactant utilized for depolymerization and the composition of final products. In the case of hydrolysis, water is utilized for de-crosslinking of the polymer, requiring a relatively high reaction pressure and temperature. The hydrolysis of polyurethanes is usually carried out at temperatures higher than 200 degrees. C. and pressures higher than 16 bars (230 psi). The hydrolysis products are original polyols and amines (isocyanate derivatives).

Glycolysis can be carried out at atmospheric pressure at about 200 degrees. C. (between 180 degrees and 240 degrees. C.). Glycolysis products are original polyols, isocyanate-containing polyols, and residual glycolytic agents (reactants).

Aminolysis can be carried out at atmospheric pressure and temperature much lower than that required for glycolysis. Aminolysis products are disubstituted ureas and original polyols.

Within the scope of the present invention “chemolysis” and “chemolysis reaction” refers to at least one type of chemolysis reaction suitable for depolymerizing polyurethane waste (or scrap) and includes glycolysis, hydrolysis, methanolysis, and aminolysis. In a preferred form, the chemolysis reaction is a glycolysis reaction. Any suitable glycol can be used in this reaction. Preferably, the glycol is a low molecular weight glycol such as dipropylene glycol, diethylene glycol, propylene glycol, ethylene glycol or mixtures of these glycols. Any suitable catalyst can be used in the glycolysis reaction such as sodium hydroxide, potassium hydroxide, sodium alcoholate, potassium alcoholate or mixtures of these catalysts.

Within the scope of the present invention, “chemolysis polyol” most preferably refers to a glycolysis polyol, produced from a glycolysis reaction.

Preferably, polyurethane waste is polyurethane foam, more preferably a rigid polyurethane foam. Preferably, chemolysis polyol of step b) is filtered to remove solid reside. Preferably, polyol of step a) is a product obtained from a previous chemolysis process hence providing a feedback loop reaction. Preferably, the polyol of step a) is a product obtained from a previous polyurethane recycling process. Preferably, the chemolysis polyol is mixed with the waste polyurethane via at least one of spraying, sipping and soaking. Preferably, the chemolysis polyol is mixed with the waste polyurethane in a grinder and wherein chemolysis polyol enters said grinder in a cross flow or counter cross flow thereby a) forming a fog-like screen at a top of the grinder to block egress of fine polyurethane dust; and b) contacting directly with the waste polyurethane to dampen any particulates formed.

More preferably, the glycolysis reaction uses one or more of the following chemicals and material:
a. Sodium Hydroxide or Potassium Hydroxide
b. Di-Ethanol Amine
c. Di-Ethyl Glycol
d. Polyurethane foam

Preferably, the glycolysis chemicals are in the following weight ratios:
Sodium Hydroxide to Di-Ethyl Glycol and to Di-Ethanol Amine is 1.0±0.5 to 45±7 to 3.5±0.5.

Preferably, the weight of polyurethane foam to the total weight of chemicals ranges from 3.0 to 1.0. More preferably, step b) is conducted in inert gas atmospheric. More preferably, carbon dioxide is injected into the chemolysis polyol before filtering. More preferably, filtering is conducted through at least one of:
a. filter press;
b. centrifuge; and
c. in-line filter.

The present invention further provides a system for polyurethane foam recycling which comprises:
a) grinder with intake portal for receiving chemolysis polyol, said grinder adapted to grind waste polyurethane in the presence of at least one chemolysis polyol therein to create wet ground polyurethane;
b) chemical recycling chamber;
c) feeding channel from grinder to chamber, to transfer wet ground polyurethane;
d) feedback channel from chemical recycling chamber to grinder by which chemolysis polyol is delivered from chemical recycling chamber to grinder.

Preferably, there is provided at step d) a filter to remove solid residue from chemolysis polyol. Preferably, there is provided additionally a means to separate products generated in chemical recycling chamber including i) chemolysis polyol and ii) recycling polyols which are usable in subsequent manufacture of new polyurethane products.

### Rigid Foams

Rigid and flexible PU foams, in short PUR and PUF foams can be distinguished depending on whether the cell structure is “open” or “closed”. In PUR foams only a few % of the cells is open and bulk densities are typically 30-35 kg/m3. The blowing agent gas contained in the cells results in a very low thermal conductivity, and the main use of such PUR foams is in insulating boards, refrigerators and freezers. Flexible PU foams have a virtually completely open cell structure with typical densities 20-45 kg/m3 and are thus not good insulators; these materials are mainly found in mattresses, furniture and seats in automobiles.

Particular usefulness of the wet grinding process of the present invention is in the field of rigid foam (PUR) recycling. Furthermore, the recycling of rigid polyurethane foams by solvolysis to produce new polyols for the purpose of producing rigid foams is generally agreed to be the most promising way of recycling. However, as noted elsewhere herein, this way is seriously complicated by the following facts:
a) PU waste/scrap must be pre-ground before further treatment;
b) dry grinding rigid foam leads to significant and hazardous dust issues;
c) wetting (during grinding) by chemical means may disrupt formulations necessary for the downstream solvolysis/chemolysis reactions i.e. any agent added during grinding must be compatible with downstream processing.

The wet grinding process of the present invention addresses and overcomes each of these issues.

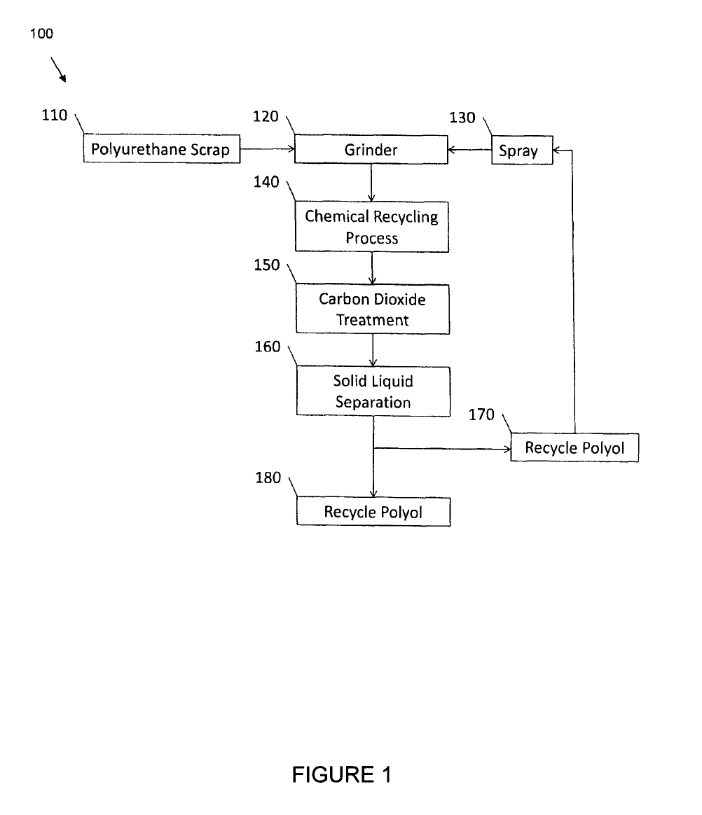

The schematic flow chart diagram FIG. 1 illustrates one embodiment of a method. The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method.

The format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 1 illustrates one embodiment of a process 100 for incorporating recycle polyol into the wet grinding process in accordance with the present invention. The description of the production method 100 refers to elements of FIG. 1; like numbers referring to like elements. The process 100 provides polyurethane 110 to be fed into grinder 120 while recycle polyol 170 is being sprayed into the grinder 120 through a spray system 130. The process 100 proceeds to have the ground polyurethane fed into chemical recycling process 140 to convert the polyurethane into recycle polyol. The process 100 further proceeds to have the recycle polyol treated with carbon dioxide 150 to precipitate any dissolved silica that was contained in the scrap polyurethane before entering solid-liquid separation 160 to remove any solid residue. The generated solid liquid recycle polyol, free of solid residues, is separated into two parts 170 and 180, where recycle polyol 170 is then fed back to the grinder 120 and recycle polyol 180 is used as a polyol material for polyurethane production.

It is a surprising discovery that when spraying recycle polyol into the grinder, the amount of the dust that is generated from grinding the polyurethane is substantially suppressed in comparison with grinding the polyurethane dry, which significantly increases the yield of the recycle polyol. Furthermore, reducing the amount of the dust from the grinding process also helps to prevent the possibility of explosion caused from electrostatic discharges in fine dusts.

It has also been favourably discovered that the recycle polyol will not react with the chemicals used in the polyurethane chemical recycling process such as sodium hydroxide, and the wet grinding process will not upset the downstream chemical processing.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

### EXAMPLES

The following examples illustrate the invention along with various non-limiting aspects of process and product.

### Example 1

### Wet Grinding of Polyurethane Foam

Example 1 illustrates the improvement of foam yield from the wet grinding process over dry grinding process. Kingspan's rigid was used in both the dry and wet grinding process test.
When grinding the foam dry, lots of fine foam dust would be blown out of the grinder. A dry grinding test showed that approximately 18.7 wt % of the foam was lost. Wet grinding of the rigid foam is carried out with the following procedures:
a. Place 500 g of foam blocks into the grinder
b. Add approximately 250 g of Recycle Polyol into the grinder
c. Spray 250 g of recycle polyol into the grinder while grinding.
d. Grind for 1 minute

The wet grinding results in 4.2 wt % loss of the foam, which is a 76% improvement over the dry grinding foam yield. The polyurethane chemical recycling process can be conducted in various recipes which are illustrated in the following table and examples:
Recipe A Recipe B Recipe C
Polyurethane 66.0% 49.9% 59.7%
DEG 30.0%45.0% 36.2%
DEA 2.6% 3.9% 3.1%
NaOH 0.8% 1.2% 1.0%

### Example 2

### Chemical Polyurethane Foam Recycling Process with Recipe A

Example 2 illustrates the chemical polyurethane foam recycling process with the foam block ground wet with the procedure as in Example 1. The chemical polyurethane recycling process was carried out with procedures that are listed as follows:
a. Dissolve 5 g of NaOH in 20 g DEA at 85 degree Celsius
b. Add DEA mixture with 225 g of DEG and increase the solution temperature to 185 degree Celsius
c. Add 1000 g of the wet ground polyurethane to the solution and maintain the solution temperature below 200 degree Celsius
d. Once all the polyurethane pieces have dissolved, cool down the solution to 65 degree Celsius and filter. Depending on the type of polyurethane, the final solution might separate into two phases.

### Example 3

### Chemical Polyurethane Foam Recycling Process with Recipe B

Example 3 illustrates the chemical polyurethane foam recycling process with the foam block ground wet with the procedure as in Example 1. The chemical polyurethane recycling process was carried out with procedures that are listed as follows:
a. Dissolve 5 g of NaOH in 20 g DEA at 85 degree Celsius
b. Add DEA mixture with 225 g of DEG and heat the solution to 185 degree Celsius
c. Add 750 g of the wet ground polyurethane to the solution and maintain the solution temperature below 200 degree Celsius
d. Once all the polyurethane pieces have dissolved, cool down the solution to 65 degree Celsius and filter. Depending on the type of polyurethane, the final solution might separate into two phases.

### Example 4

### Chemical Polyurethane Foam Recycling Process with Recipe C

Example 4 illustrates the chemical polyurethane foam recycling process with the foam block grinded wet with the procedure as in Example 1. The chemical polyurethane recycling process was carried out with the following procedures are listed as follows:
a. Dissolve 5 g of NaOH in 20 g DEA at 85 degree Celsius
b. Add DEA mixture with 225 g of DEG and heat the solution to 185 degree Celsius
c. Adding 500 g of the wet grinded polyurethane to the solution and maintain the solution temperature below 200 degree Celsius
d. Once all the polyurethane pieces have dissolved, cool down the solution to 65 degree Celsius and filter. Pending on the type of polyurethane, the final solution might separate into two phases.

### Example 5

### Chemical Polyurethane Foam Recycling Process with Recipe A and Carbon Dioxide Treatment

Example 5 illustrates the chemical polyurethane foam recycling process and the carbon dioxide treatment to remove silica residue with the foam block ground wet with the procedure as in Example 1. The chemical polyurethane recycling process was carried out with the following procedures are listed as follows:
a. Dissolve 5 g of NaOH in 20 g DEA at 85 degree Celsius
b. Add DEA mixture with 225 g of DEG and heat the solution to 185 degree Celsius
c. Add 1000 g of the wet ground polyurethane to the solution and maintain the solution temperature below 200 degree Celsius
d. Once all the polyurethane pieces have dissolved, cool down the solution to 65 degree Celsius and inject carbon dioxide into the solution to precipitate silica that might exist as silicon oxide in the polyurethane material as filler.
e. Filter the solution to remove any solid residue
f. Depending on the type of polyurethane, the final solution might separate into two phases.

### Example 6

### Chemical Polyurethane Foam Recycling Process with Recipe A Under inert Gas Environment and Carbon Dioxide Treatment

Example 6 illustrates the chemical polyurethane foam recycling process and the carbon dioxide treatment to remove silica residue with the foam block grinded wet with the procedure as in Example 1. The chemical polyurethane recycling process was carried out with the following procedures are listed as follows:
a. Dissolve 5 g of NaOH in 20 g DEA at 85 degree Celsius
b. Add DEA mixture with 225 g of DEG and heat the solution to 185 degree Celsius
c. Add 1000 g of the wet ground polyurethane to the solution and maintain the solution temperature below 200 degree Celsius while purging nitrogen into the solution.
d. Once all the polyurethane pieces have dissolved, cool down the solution to 65 degree Celsius and inject carbon dioxide into the solution to precipitate silica that might exist as silicon oxide in the polyurethane material as filler.
e. Filter the solution to remove any solid residue
f. Depending on the type of polyurethane, the final solution might separate into two phases.

1. A process of chemically recycling polyurethane waste comprising the steps of:
a) wet grinding the polyurethane waste with a polyol to form a wet ground polyurethane;
b) subjecting wet ground polyurethane to a chemolysis reaction to produce at least one chemolysis polyol; and
c) using the chemolysis polyol produced at step b) in the wet grinding of step a), therein to control dust generation during said grinding and to improve efficiency of the chemical recycling.

2. The process of claim 1 wherein the polyurethane waste is polyurethane foam.

3. The process of claim 1 wherein the polyurethane waste is rigid polyurethane foam.

4. The process of claim 1 wherein the chemolysis reaction is glycolysis.

5. The process of claim 1 wherein the chemolysis reaction is hydrolysis.

6. The process of claim 1 wherein the chemolysis reaction is aminolysis.

7. A process of claim 1 wherein chemolysis polyol of step b) is filtered to remove solid reside.

8. The process of claim 1 wherein polyol of step a) is a product obtained from a previous chemolysis process.

9. The process of claim 1 wherein the polyol of step a) is a product obtained from a previous polyurethane recycling process.

10. The process of claim 1 wherein the chemolysis polyol is mixed with the waste polyurethane via at least one of spraying, sipping and soaking.

11. The process of claim wherein chemolysis polyol is mixed with the waste polyurethane in a grinder and wherein chemolysis polyol enters said grinder in a cross flow or counter cross flow thereby a) forming a fog-like screen at a top of the grinder to block egress of fine polyurethane dust; and b) contacting directly with the waste polyurethane to dampen any particulates formed.

12. The process of claim 4 wherein glycolysis reaction uses one or more of the following chemicals and material:
a. Sodium Hydroxide or Potassium Hydroxide
b. Di-Ethanol Amine
c. Di-Ethyl Glycol
d. Polyurethane foam

13. The process of claim 12 wherein the chemicals are in the following weight ratios:
Sodium Hydroxide to Di-Ethyl Glycol and to Di-Ethanol Amine is 1.0±0.5 to 45±7 to 3.5±0.5.

14. The process of claim 12 where the weight of polyurethane foam to the total weight of chemicals ranges from 3.0 to 1.0.

15. The process of claim 1, where step b) is conducted in inert gas atmospheric.

16. The process of claim 7 wherein carbon dioxide is injected into the chemolysis polyol before filtering.

17. The process of claim 7 wherein the filtering is conducted through at least one of:
a. filter press;
b. centrifuge; and
c. in-line filter.

18. Wet ground waste polyurethane for use in a subsequent chemolysis reaction comprises a waste polyurethane ground in the presence of a chemolysis polyol.

19. Wet ground waste polyurethane of claim 18 wherein the waste polyurethane is polyurethane foam.

20. Wet ground waste polyurethane of claim 18 wherein the waste polyurethane is rigid polyurethane foam.

21. Wet ground waste polyurethane of claim 18 wherein the chemolysis reaction is glycolysis.

22. Wet ground waste polyurethane of claim 18 wherein the chemolysis reaction is hydrolysis.

23. Wet ground waste polyurethane of claim 18 wherein the chemolysis reaction is aminolysis.

24. A system for polyurethane foam recycling which comprises:
a) a grinder with intake portal for receiving chemolysis polyol, said grinder adapted to grind waste polyurethane in the presence of at least one chemolysis polyol therein to create wet ground polyurethane;
b) a chemical recycling chamber;
c) a feeding channel from grinder to chamber, to transfer wet ground polyurethane; and
d) feedback channel from chemical recycling chamber to grinder by which chemolysis polyol is delivered from chemical recycling chamber to grinder.

25. The system of claim 24 wherein the waste polyurethane is polyurethane foam.

26. The system of claim 24 wherein the polyurethane waste is rigid polyurethane foam.

27. The system of claim 24 wherein the chemolysis reaction is glycolysis.

28. The system of claim 24 wherein the chemolysis reaction is hydrolysis.

29. The system of claim 24 wherein the chemolysis reaction is aminolysis.

30. The system of claim 24 additionally comprising, at step d) a filter to remove solid residue from chemolysis polyol.

31. The system of claim 24 additionally comprising a means to separate products generated in chemical recycling chamber including i) chemolysis polyol and ii) recycling polyols which are usable in subsequent manufacture of new polyurethane products
